(19) United States
(12) Patent Application Publication
(10) Pub. No.: US 2018/0355833 A1
(43) Pub. Date: Dec. 13, 2018

(54) SPRAY ORIFICE DISK AND VALVE

(71) Applicant: Robert Bosch GmbH, Stuttgart (DE)

(72) Inventors: Tilo Starkert, Dettingen Unter Teck (DE); Franz Thoemmes, Bietigheim-Bissingen (DE); Laurent Jeannel, Ditzingen (DE)

(21) Appl. No.: 16/060,484

(22) PCT Filed: Oct. 24, 2016
(86) PCT No.: PCT/EP2016/075529

§ 371 Date: Jun. 8, 2018

(30) Foreign Application Priority Data
Dec. 15, 2015 (DE) 10 2015 225 342.2

(51) Int. Cl. F02M 61/18; F02M 61/16

(52) U.S. Cl. CPC F02M 61/1853; F02M 61/184; F02M 61/1813; F02M 61/162

(57) ABSTRACT

A spray orifice disk for a valve for a flowing fluid and, in particular, for a metering or injection valve for an internal combustion engine, including a disk body and a spray orifice set-up, which is formed in the disk body and is configured with at least three spray orifices, each for dispensing supplied fluid. The spray orifices are being configured to form a swirl geometry of the spray orifice disk in such a manner that during operation, a combined spray is formed from at least three individual jets by interaction of a plurality of at least three individual jets of fluid emerging in atomized form from the spray orifices.

### BACKGROUND INFORMATION

The present invention relates to a spray orifice disk and a valve. The present invention relates to, in particular, a spray orifice disk for a valve for a flowing fluid and, in particular, for a metering or injection value for an internal combustion engine, as well as to a valve for a flowing fluid and, in particular, a metering or an injection valve for an internal combustion engine.

In valves for flowing fluids and, in particular, in metering or injection valves for internal combustion engines, in particular specific embodiments, a valve seat body, which terminates a valve chamber, has a so-called spray orifice disk downstream from it in the direction of flow of the fluid, the spray orifice disk including at least one spray orifice, which is used for dispensing the fluid from the valve chamber into a delivery space, for example, into a combustion chamber or the like.

In this context, so-called turbulence atomization of the flowing fluid in the transition from the spray orifice of the spray orifice disk to the delivery space of the fluid is often used for treatment. In particular, in the case of comparatively low pressures, this may result in non-uniform jet distribution and/or in comparatively large drops. In many applications, this is not desired, or this is even disadvantageous.

### SUMMARY

An example spray orifice disk of the present invention, may include the advantage that when used in a valve, a comparatively uniform distribution of the droplets in the atomization cone may be attained with a reduction in the droplet size. According to the present invention, this may be achieved, for example, in that a spray orifice disk for a valve for a flowing fluid and, in particular, for a metering or injection valve for an internal combustion engine, is provided; the spray orifice disk including a disk body and a spray orifice set-up formed in the disk body, the spray orifice set-up being configured with at least three spray orifices, each for dispensing supplied fluid; the spray orifices being configured to form a swirl geometry of the spray orifice disk in such a manner, that during operation, a combined spray is formed from at least three individual jets by interaction of a plurality of at least three individual jets of fluid emerging in atomized form from the spray orifices. Since, according to the present invention, a plurality of at least three spray orifices are configured to form a swirl geometry of the spray orifice disk in such a manner, that during operation, a combined spray is formed from at least three individual jets by interaction of a plurality of at least three individual jets of fluid emerging from the spray orifices in atomized form, a particularly uniform distribution of the atomized fluid within the entire spray cone may be attained with a reduction in the droplet size.

In the technical context of the present invention, the terms atomization cone, spray cone and spray are used synonymously.

In one advantageous developmental form of the spray orifice disk according to the present invention, the swirl geometry is configured in such a manner, that the oval cross-sectional pattern of the atomization cone or spray may be generated (i) at low pressures in the range of approximately 3·10⁵ Pa (3 bar) to approximately 10·10⁵ Pa (10 bar), (ii) with a uniform distribution of the fluid in the spray, and/or (iii) with a reduced droplet size of the spray, having an SMD value of less than 80 μm. In this manner, areas of application of the spray orifice disk of the present invention and of a valve equipped with the spray orifice disk are also possible, in which, to date, only comparatively poorer results were able to be obtained, for example, in view of the uniformity of the atomization cone and/or the distribution of the droplet sizes.

According to the present invention, the swirl geometry of the spray orifice disk may be adapted by suitably adjusting different structural and, in particular, geometric parameters alone or in combination, in order to generate the effects provided by the present invention.

In one preferred specific embodiment of the spray orifice disk of the present invention, the spray orifices and/or the swirl geometry of the spray orifice disk are configured in such a manner, that individual jets from spray orifices meet at a point or in a surrounding area of a point downstream from the spray orifice disk in the flow direction of the fluid, in order to form a combined spray in atomized form. By merging at a point or in a surrounding area of a point, the individual jets discharged from the spray orifices enter into fluid-mechanical interaction with each other, in order to obtain, in this manner, the combined spray in atomized form, having a particularly uniform distribution of the fluid droplets with a reduced droplet size. The surrounding area preferably has a diameter, which does not exceed a diameter of the individual jets.

In one preferred example embodiment of the present invention, it is provided that swirl be introduced, in a particularly simple manner, into the combined spray to be formed. In one advantageous further refinement of the spray orifice disk of the present invention, this is achieved by configuring the spray orifices and/or the swirl geometry of the spray orifice disk in such a manner, that individual jets from spray orifices meet radially and/or tangentially with respect to each other, displaced by an offset, at a point or in a surrounding area of a point, downstream from the spray orifice disk in the flow direction of the fluid, in order to form a combined spray.

In this context, it must be ensured that the individual jets, which are produced by the spray orifices and are intended to be brought together to form a combined spray, are able to enter fluid-mechanically into interaction with each other. To that end, the offset of the jets relative to each other, be it radial and/or tangential, may not be formed in excess. Therefore, in one preferred specific embodiment, it is provided that the offset of a specific individual jet not exceed the diameter of the specific individual jet and/or the diameter of the spray orifice producing the specific individual jet.

In one further refinement of the spray orifice disk of the present invention, the swirl and/or momentum able to be introduced into the combined spray to be formed may be adjusted in a particularly simple manner, in that the spray orifices and/or the swirl geometry of the spray orifice disk are formed in such a manner, in particular, by selection of the orifice angle of the spray orifices relative to a center axis of the spray orifice disk. In this manner, the momentum of the individual jets and of the combined spray, the jet angle of the individual jets, the droplet size, the size distribution of the droplets and/or the distribution of the droplets in the combined spray are also adjustable.

Different flow ratios may be used for the individual jets, which are to be brought together to form a combined spray.

Thus, in one preferred specific embodiment, the spray orifices and/or the swirl geometry of the spray orifice disk are configured in such a manner, in particular, by selection of an increased length of the spray orifices, that due to this, a specific individual jet may be formed as a laminar jet.

Alternatively, or in addition, in another further refinement of the spray orifice disk of the present invention, the spray orifices and/or the swirl geometry of the spray orifice disk may be configured in such a manner, in particular, by selection of a reduced length of the spray orifices, that due to this, a specific individual jet may be formed as a turbulent jet.

The cross-sectional shape of the spray orifices of the spray orifice set-up formed in the spray orifice disk may also be used in its shape, in order to influence the characteristics and the geometry of the individual jets, and consequently, of the spray to be combined.

Thus, in another alternative of the spray orifice disk of the present invention, it is provided that a specific spray orifice have a circular or a non-circular and, in particular, an oval or elliptical cross section.

The present invention also relates to a valve for a flowing fluid and, in particular, a metering or injection valve for an internal combustion engine. According to the present invention, this valve is configured with a valve seat body, which terminates a valve chamber and has a valve opening, as well as with a spray orifice disk situated downstream from the valve seat body. The spray orifice disk has the shape described according to the present invention, so that upon use of the valve of the present invention, an atomization cone or spray having a comparatively uniform distribution and possibly reduced mean droplet size is generated.

### BRIEF DESCRIPTION OF THE DRAWINGS

Specific embodiments of the present invention are described in detail, with reference to the figures.

FIG. 1 is a schematic and sectional side view of a part of a valve according to the present invention.

FIGS. 2 and 3 show a schematic and sectional side view and a view from below of a specific embodiment of a spray orifice disk according to the present invention, having a 4-hole configuration.

FIGS. 4 and 5 show a combined spray, as may be produced by a specific embodiment of the spray orifice disk according to the present invention, and namely, a lateral snapshot of the spray and a cross-sectional density profile, respectively.

FIGS. 6 and 7 show side views of individual laminar and turbulent jets, respectively, as well as their merging to form a combined spray, as may be produced in a specific embodiment of the spray orifice disk according to the present invention.

### DETAILED DESCRIPTION OF EXAMPLE EMBODIMENTS

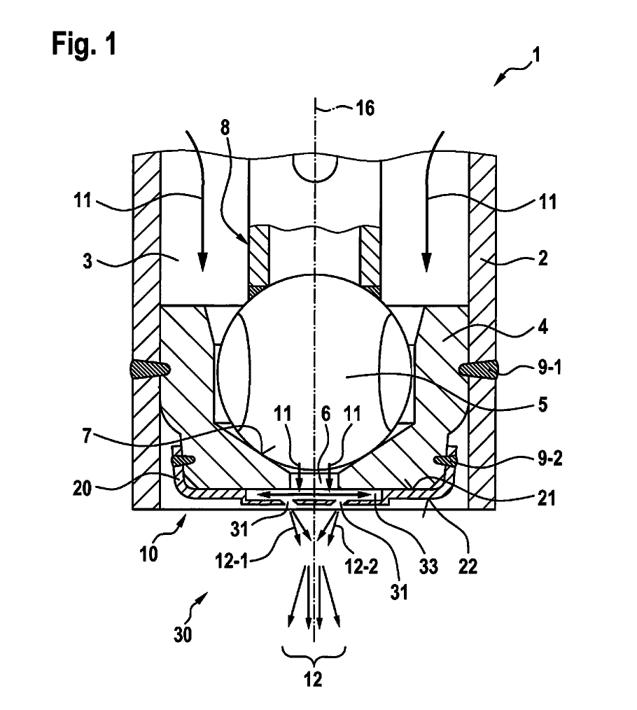

Below, exemplary embodiments of the present invention are described in detail, with reference to FIGS. 1 through 7. Identical and equivalent elements and components, as well as elements and components that function equally or equivalently, are denoted by the same reference numerals. A detailed description of designated elements and components is not repeated in every instance of their appearance.

The depicted features and further characteristics may be isolated from one another in any desired form, and combined arbitrarily with one another, without departing from the essence of the present invention.

FIG. 1 shows a schematic and sectional side view of a detail of a specific embodiment of a valve 1 according to the present invention, which utilizes a spray orifice disk 10 of the present invention.

Valve 1 includes a valve seat support 2, in the lower region of which valve seat 7 is formed and attached to valve seat support 2 via first fastening elements 9-1. At its lower end, a valve member 8 includes a closing head 5, which, in this case, is spherically shaped and may be seated on valve seat 7 in a controlled manner, in order to occlude or uncover a valve opening 6 in a controlled manner. Valve seat 7 is formed by a conical surface of a valve seat body 4 and includes valve opening 6 at its lower end. At the endface of valve seat body 4 and opposite to valve opening 6, a spray orifice disk 10 of the present invention, which includes a disk body 20 and a spray orifice set-up 30, is attached to the outside of valve seat body 4 by second fastening elements 9-2.

In disk body 20, spray orifice disk 10 includes several openings, via which a plurality of spray orifices 31 of spray orifice set-up 30 are formed.

Flowing fluid 11 leaves valve 1 through a specific spray orifice 31, in, in each instance, the form of an individual jet 12-1, 12-2, which appears as an atomization cone and may also be referred to synonymously as a spray or spray cone.

A recess 33 is formed in upper side 21 of disk body 20, the recess interacting with valve chamber 6 as an antechamber and receiving flowing fluid 11 for distribution to the different spray orifices 31.

In the specific embodiment of valve 1 of the present invention, as shown in FIG. 1, the spray orifice disk 10 used there is formed with a plurality of spray orifices 31 of substantially identical nature, but this is not essential. However, in this case, each of spray orifices 31 has the same inclination with respect to the center axis 16 in the form of a central axis of symmetry, and actually, in each instance, in the plane, which is defined by lower side 22 of spray orifice disk 10 and with respect to central center axis 16.

During operation, a plurality of individual jets 12-1, 12-2 are produced from flowing fluids 11 as a function of the number of spray orifices 31. Due to the overall development of spray orifices 31 and/or of the swirl geometry of spray orifice disk 10, individual jets 12-1, 12-2 interact with each other, in particular, in the form of a collision, and in so doing, form a combined spray 12, spray cone or atomization cone.

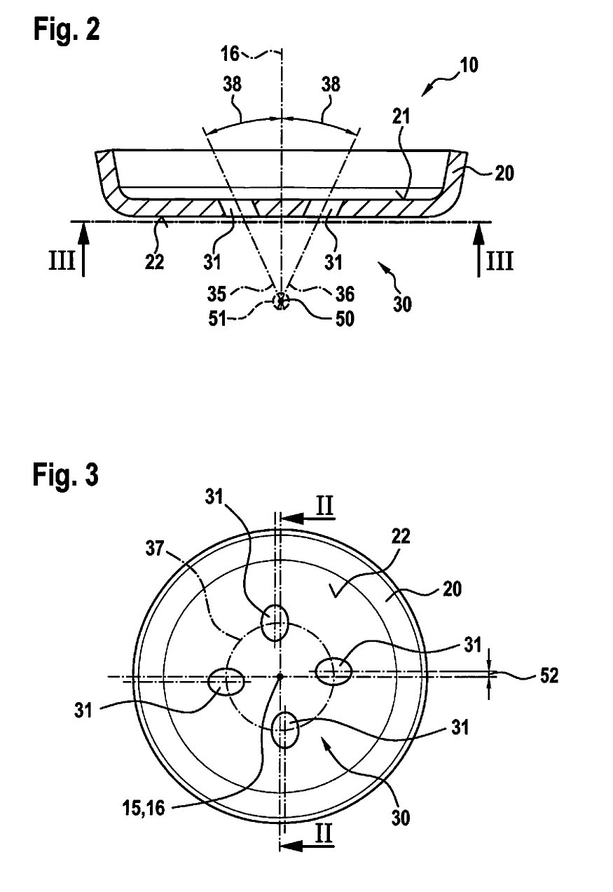

FIGS. 2 and 3 show a schematic and sectional side view and a view of lower side 22 from below, respectively, of a specific embodiment of the spray orifice disk 10 of the present invention, which has a 4-hole geometry or configuration.

Spray orifice disk 10 according to FIGS. 2 and 3 is made up of a disk body 20 having an upper side 21 and a lower side 22. Four spray orifices 31 are formed, which lie essentially on a configuration circle 37 and extend from upper side 21 to lower side 22 of disk body 20. Spray orifices 31 possess spray orifice axes 35, 36, which have identical angles of inclination 38 with respect to central center axis 16, which means that spray orifice axes 35, 36 essentially meet at a point 50 or in a surrounding area 51 of point 50, underneath lower side 22 of the spray orifice disk.

In the specific embodiment of FIGS. 2 and 3, spray orifice set-up 30 is made up of four identical spray orifices 31. However, the number four is not obligatory, as long as at least three spray orifices 31 are provided and formed in such a manner, that they produce a common and combined spray 12 for merging the individual jets 12-1, 12-2 generated by them.

In specific embodiments, spray orifice axes 35 and 36 do not meet exactly at a point 50; instead, they traverse a small surrounding area 51 of point 50 as an ideally conceived, common intersection of spray orifice axes 35, 36.

In different specific embodiments of the spray orifice disk 10 of the present invention, this is achieved in that, according to FIG. 3, spray orifices 31 are displaced radially and/or tangentially by an offset 52 from the ideal axes, which lead to an exact intersection 50 underneath lower side 22 of spray orifice disk 10.

Offset 52 is calculated in such a manner, that an interaction of individual jets 12-1, 12-2 for combining to form spray 12 may still occur in surrounding area 51 of ideal intersection 50. In particular, offset 52 does not exceed the diameter of respective spray orifice 31 and/or of the individual jet 12-1, 12-2 produced by respective spray orifice 31.

FIG. 2 provides the view of the set-up from FIG. 3 in the sectional plane II-II. FIG. 3 shows, in turn, the view of the set-up of FIG. 2, towards the plane of view III-III.

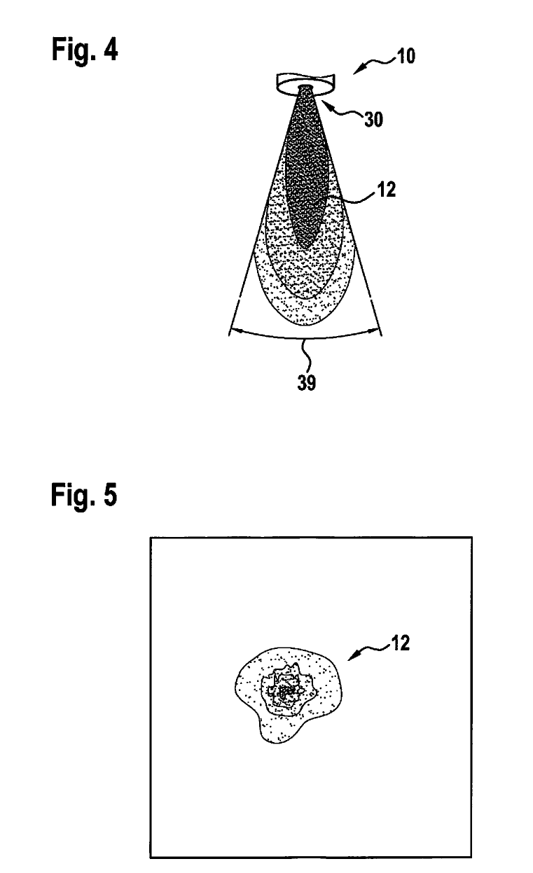

FIGS. 4 and 5 show a lateral snapshot and a cross-sectional view of a combined spray 12 produced by a specific embodiment of the spray orifice disk 10 of the present invention, having a spray orifice set-up 30.

After the merging of individual jets 12-1, 12-2, which are produced by spray orifices 31 of spray orifice set-up 30, combined spray 12 possesses a fanning-out angle 39, which is generally controllable, using the geometry and the general design of spray orifices 31 and/or of the swirl geometry of spray orifice disk 10.

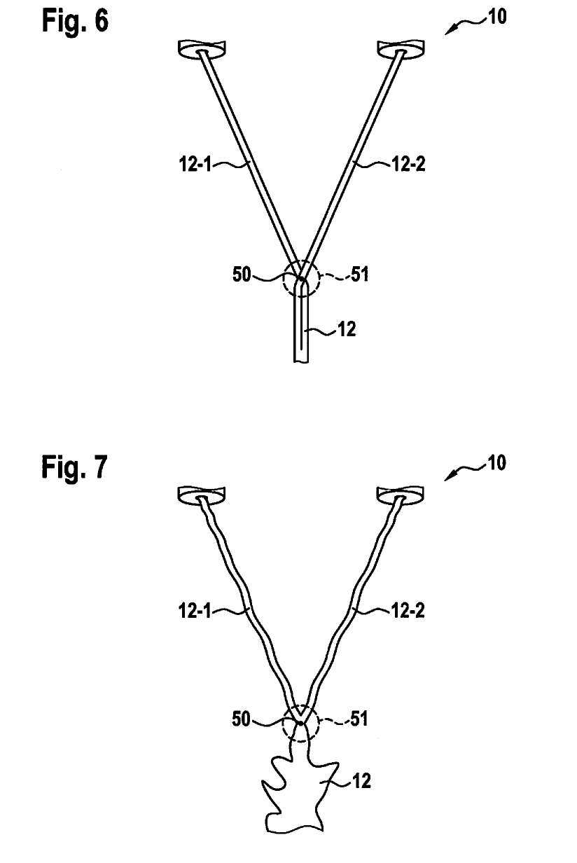

FIGS. 6 and 7 show the effect of two further specific embodiments of spray orifice disk 10 of the present invention, in which individual jets 12-1, 12-2 merge with each other via interaction in surrounding area 51 of ideal intersection 50 of spray orifice axes 35, 36, to form a common spray 12. In this case, only two individual jets 12-1, 12-2 are depicted. This serves to simplify the representation, although according to the present invention, at least three jets interact with each other.

FIG. 6 shows individual laminar jets 12-1 and 12-2, which interact to form a combined spray 12.

On the other hand, the developmental form according to FIG. 7 provides individual turbulent jets 12-1, 12-2 for interaction in surrounding area 51 of ideal intersection 50 of spray orifice axes 35, 36, to form combined spray 12.

These and further features and characteristics of the present invention are clarified further in light of the following explanations:

One object of the present invention is to improve conventional atomization designs.

At low pressures of 3 bar to 10 bar, conventional treatment concepts, e.g., including turbulence atomization, produce non-uniform jet distributions and/or relatively large droplet sizes having, e.g., SMD values of ca. 80 μm to 150 μm.

The embodiments of the present invention produce a more uniform distribution inside of spray cone 12 and a marked reduction in the droplet size in the spray.

The approach of the present invention is, inter alia, to combine swirl atomization with atomization by jet collision; in particular, in a preferred manner, three or more individual jets 12-1, 12-2 meeting, slightly offset radially, at a point downstream from spray orifice disk 10.

The collision and the eccentricity of the jets produces a fine and uniform atomization 12 having swirl or angular momentum.

The momentum and, consequently, the jet angle and the droplet sizes, may be changed, using the angle of spray orifices 31 with respect to the valve axis or center axis 16 of spray orifice disk 10.

FIGS. 2 through 5 show examples of a spray orifice disk 10 having a 4-hole configuration. Spray orifices 31 are introduced into the spray orifice disk at an angle of inclination 38 to the vertical valve axis 16. Offset 52 of spray orifices 31 produces swirl in the region of the collision or of the collision point. A large angle of inclination 38 may be used to produce a high collision momentum and/or a greater jet angle.

Spray orifices 31 that are long in comparison with their diameter produce laminar primary jets 12-1, by which the swirl momentum is intensified (compact collision stream).

Spray orifices 31 that are short in comparison with their diameter increase the turbulence in the primary jets more.

The following advantages of the present invention become apparent:

(i) uniform and finely atomized spray 12 having a uniform mass distribution in spray cone 12;

(ii) effective atomization, even at low pressures, e.g., in comparison with turbulence atomization;

(iii) inexpensive design of spray orifice disk 10, which may be produced by stamping or laser drilling.

1-10. (canceled)

11. A spray orifice disk for a valve for a flowing fluid, and for a metering or injection valve for an internal combustion engine, the spray orifice disk comprising:
a disk body; and
a spray orifice set-up formed in the disk body, the spray orifice set-up configured with at least three spray orifices, each for dispensing supplied fluid;
wherein the spray orifices are configured to form a swirl geometry of the spray orifice disk in such a manner that during operation, a combined spray is formed from at least three individual jets by interaction of a plurality of at least three individual jets of fluid emerging in atomized form from the spray orifices.

12. The spray orifice disk as recited in claim 11, wherein at least one of: (i) the spray orifices, and (ii) the swirl geometry of the spray orifice disk, are configured in such a manner that the combined spray may be produced at least one of:
(i) at low pressures in the range of approximately 3·10⁵ Pa (3 bar) to approximately 10·10⁵ Pa (10 bar),
(ii) to have a uniform distribution of the fluid in the combined spray, and
(iii) to have a reduced droplet size of the combined spray, having an SMD value of less than 80 μm.

13. The spray orifice disk as recited in claim 11, wherein at least one of: (i) the spray orifices, and (ii) the swirl geometry of the spray orifice disk, are configured in such a manner that the individual jets from the spray orifices meet at a point or in a surrounding area of a point, downstream from the spray orifice disk in a flow direction of the fluid, to form the combined spray in atomized form.

14. The spray orifice disk as recited in claim 11, wherein at least one of: (i) the spray orifices, and (ii) the swirl geometry of the spray orifice disk, are configured in such a manner that the individual jets from the spray orifices meet, displaced at least one of radially and tangentially, to each other by an offset, at a point or in a surrounding area of a point, downstream from the spray orifice disk in a flow direction of the fluid, to form the combined spray.

15. The spray orifice disk as recited in claim 14, wherein the offset of a specific one of the individual jets does not exceed at least one of: (i) a diameter of the specific one of the individual jets, and (ii) a diameter of a spray orifice of the spray orifices producing the specific one of the individual jets.

16. The spray orifice disk as recited in claim 11, wherein at least one of: (i) the spray orifices, and (ii) the swirl geometry of the spray orifice disk, are configured, by selection of orifice angles of the spray orifices relative to a center axis of the spray orifice disk, that due to orifice angles, momentum of the individual jets and momentum of the combined spray, at least one of: (i) a jet angle of individual jets, (ii) droplet size, (ii) size distribution, and (iii) a distribution of droplets in the combined spray, are adjustable.

17. The spray orifice disk as recited in claim 11, wherein at least one of: (i) the spray orifices, and (ii) the swirl geometry of the spray orifice disk, are configured by selection of an increased length of the spray orifices, that due to the length, a specific one of the individual jets is formed as a laminar jet.

18. The spray orifice disk as recited in claim 11, wherein at least one of: (i) the spray orifices, and (ii) the swirl geometry of the spray orifice disk, are configured by selection of a reduced length of the spray orifices, that due to the length, a specific one of the individual jets is formed as a turbulent jet.

19. The spray orifice disk as recited in claim 11, wherein a specific one of the spray orifices has one of a circular, an oval, and an elliptical cross section.

20. A valve for a flowing fluid and a metering or injection valve for an internal combustion engine, comprising:
a valve seat body which terminates a valve chamber and has a valve opening; and
a spray orifice disk situated downstream from the valve seat body, the spray orifice disk including a disk body, and a spray orifice set-up formed in the disk body, the spray orifice set-up configured with at least three spray orifices, each for dispensing supplied fluid, wherein the spray orifices are configured to form a swirl geometry of the spray orifice disk in such a manner that during operation, a combined spray is formed from at least three individual jets by interaction of a plurality of at least three individual jets of fluid emerging in atomized form from the spray orifices.
